(19) United States
(12) Patent Application Publication
(10) Pub. No.: US 2025/0358794 A1
(43) Pub. Date: Nov. 20, 2025

(54) USER PLANE ENHANCEMENTS TO AVOID TRANSMISSION OF OUTDATED DATA UNITS

(71) Applicant: LENOVO (SINGAPORE) PTE LIMITED, SINGAPORE (SG)

(72) Inventors: Joachim LÖHR, Wiesbaden (DE); Shwetha Sreejith, Bad Homburg (DE); Prateek Basu Mallick, Dreieich (DE)

(21) Appl. No.: 18/667,815

(22) Filed: May 17, 2024

(51) Int. Cl. H04W 72/04

(52) U.S. Cl. CPC H04W 72/04

(57) ABSTRACT

Various aspects of the present disclosure relate to enhancing the functionality of a user plane protocol stack, such as by synchronizing or associating certain aspects of a radio link control (RLC) layer and a Packet Data Convergence Protocol (PDCP) layer to one another. For example, the present disclosure introduces a new timer to the RLC layer that starts when the RLC layer triggers a reordering timer in the PDCP layer (e.g., by the RLC later delivering an out of order data packet to the PDCP layer). As another example, the present disclosure enhances user plane transmissions to avoid, mitigate, and/or prevent the transmission/retransmission of outdated packets, such as outdated RLC data units.

### TECHNICAL FIELD

The present disclosure relates to wireless communications, and more specifically to user plane enhancements for wireless communications systems.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Extended Reality, or XR, encompasses different types of realities, including virtual reality (VR), which can be a rendered version of a delivered visual and audio scene, augmented reality (AR), where a user is provided with content overlaid upon a currently viewed environment, mixed reality (MR), where virtual elements are inserted into a physical scene, and so on. Thus, XR can refer to real and/or virtual environments or human-machine interactions generated by computer technology and wearables.

In some cases, XR communications, such as those that support content delivery for multimedia applications (e.g., interactive and/or immersive media applications) often have challenging latency and data rate requirements associated with content delivery in both uplink (UL) and downlink (DL) directions.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support and provide user plane enhancements for wireless communications systems.

Some implementations of the method and apparatuses described herein may further include a UE for wireless communication, comprising at least one memory and at least one processor coupled with the at least one memory and configured to cause the UE to receive, by a radio link control (RLC) transmission entity, information from an upper layer, determine, by the RLC transmission entity and based at least in part on the received information, one or more RLC packet data units (PDUs) that satisfy a condition, trigger, by the RLC transmission entity, transmission of RLC control information that comprises one or more sequence numbers (SNs) associated with the one or more RLC PDUs that satisfy the condition, generate an RLC control PDU that includes the RLC control information, and transmit the generated RLC control PDU from the RLC transmission entity to a peer receiving RLC entity.

In some implementations of the method and apparatuses described herein, the information received from the upper layer comprises a discard indication for the one or more RLC PDUs received from a packet data convergence protocol (PDCP) layer.

In some implementations of the method and apparatuses described herein, the at least one processor is further configured to cause the UE to maintain the one or more RLC PDUs determined to satisfy the condition in a corresponding buffer in response to receiving the discard indication from the PDCP layer.

In some implementations of the method and apparatuses described herein, the one or more RLC PDUs that satisfy the condition comprise RLC PDUs for which an associated delay budget is exceeded.

In some implementations of the method and apparatuses described herein, the at least one processor is configured to cause the UE to determine an RLC PDU satisfies the condition when a PDCP discard timer of a corresponding PDCP service data unit (SDU) is expired.

In some implementations of the method and apparatuses described herein, the RLC PDU includes a field that indicates a smallest SN value for the one or more SNs and a bitmap field that indicates the one or more RLC PDUs that satisfy the condition.

In some implementations of the method and apparatuses described herein, the bitmap field indicates outdated RLC PDUs and RLC PDUs that are not outdated.

Some implementations of the method and apparatuses described herein may further include a processor for wireless communication, comprising at least one controller coupled with at least one memory and configured to cause the processor to receive, by an RLC transmission entity, information from an upper layer, determine, by the RLC transmission entity and based at least in part on the received information, one or more RLC PDUs that satisfy a condition, trigger, by the RLC transmission entity, transmission of RLC control information that comprises one or more SNs associated with the one or more RLC PDUs that satisfy the condition, generate an RLC control PDU that includes the RLC control information, and transmit the generated RLC control PDU from the RLC transmission entity to a peer receiving RLC entity.

In some implementations of the method and apparatuses described herein, the information received from the upper layer comprises a discard indication for the one or more RLC PDUs received from a PDCP layer.

In some implementations of the method and apparatuses described herein, the at least one controller is further configured to cause the processor to maintain the one or more RLC PDUs determined to satisfy the condition in an RLC buffer in response to receiving the discard indication from the PDCP layer.

In some implementations of the method and apparatuses described herein, the one or more RLC PDUs that satisfy the condition comprise RLC PDUs for which an associated delay budget is exceeded.

In some implementations of the method and apparatuses described herein, the at least one controller is configured to cause the processor to determine an RLC PDU satisfies the condition when a PDCP discard timer of a corresponding PDCP SDU is expired.

In some implementations of the method and apparatuses described herein, the RLC PDU includes a field that indicates a smallest SN value for the one or more SNs and a bitmap field that indicates the one or more RLC PDUs that satisfy the condition.

In some implementations of the method and apparatuses described herein, the bitmap field indicates outdated RLC PDUs and RLC PDUS that are not outdated.

Some implementations of the method and apparatuses described herein may further include a method performed by a UE, the method comprising receiving, by an RLC transmission entity, information from an upper layer, determining, by the RLC transmission entity and based at least in part on the received information, one or more RLC PDUs that satisfy a condition, triggering, by the RLC transmission entity, transmission of RLC control information that comprises one or more SNs associated with the one or more RLC PDUs that satisfy the condition, generating an RLC control PDU that includes the RLC control information, and transmitting the generated RLC control PDU from the RLC transmission entity to a peer receiving RLC entity.

In some implementations of the method and apparatuses described herein, the information received from the upper layer comprises a discard indication for the one or more RLC PDUs received from a PDCP layer.

In some implementations of the method and apparatuses described herein, the method further comprises maintaining the one or more RLC PDUs determined to satisfy the condition in an RLC buffer in response to receiving the discard indication from the PDCP layer.

Some implementations of the method and apparatuses described herein may further include network entity for wireless communication, comprising at least one memory and at least one processor coupled with the at least one memory and configured to cause the network entity to receive, at an RLC receiving entity, an RLC control PDU from a peer RLC transmission entity, wherein the RLC control PDU includes RLC control information that comprises one or more SNs associated with one or more RLC PDUs that satisfy a condition and trigger, by the RLC receiving entity, a STATUS report based on the RLC control information from the RLC control PDU.

In some implementations of the method and apparatuses described herein, the STATUS report comprises information that indicates a positive and negative acknowledgement for one or more RLC PDUs.

In some implementations of the method and apparatuses described herein, the STATUS report comprises information that indicates a positive acknowledgement for the one or more RLC PDUs indicated by the by the RLC control PDU.

### BRIEF DESCRIPTION OF THE DRAWINGS

FIG. 1 illustrates an example of a wireless communications system in accordance with aspects of the present disclosure.

FIG. 2 illustrates an example block diagram that depicts communications between a receiving entity and a transmission entity in accordance with aspects of the present disclosure.

FIG. 3 illustrates an example diagram that depicts PDCP and RLC reception in accordance with aspects of the present disclosure.

FIG. 4 illustrates an example diagram that depicts PDCP and RLC reception after PDCP timer expiration in accordance with aspects of the present disclosure.

FIGS. 5A-5B illustrate example control PDU structures in accordance with aspects of the present disclosure.

FIG. 6A illustrates an example diagram that depicts a PDCP indication to an RLC in accordance with aspects of the present disclosure.

FIG. 6B illustrates an example diagram that depicts an RLC receiving entity sending an indication to a transmission entity in accordance with aspects of the present disclosure.

FIG. 7 illustrates an example control PDU in accordance with aspects of the present disclosure.

FIG. 8 illustrates an example of a user equipment (UE) in accordance with aspects of the present disclosure.

FIG. 9 illustrates an example of a processor in accordance with aspects of the present disclosure.

FIG. 10 illustrates an example of a network equipment (NE) in accordance with aspects of the present disclosure.

FIG. 11 illustrates a flowchart of a method performed by a UE in accordance with aspects of the present disclosure.

FIG. 12 illustrates a flowchart of a method performed by an NE in accordance with aspects of the present disclosure.

### DETAILED DESCRIPTION

XR communications, such as those that support content delivery for multimedia applications (e.g., interactive or immersive media applications) often have challenging latency and data rate requirements associated with content delivery in both uplink (UL) and downlink (DL) directions. To support such communications, a network may enhance certain aspects of its data communications protocols, such as aspects of a user plane protocol stack.

For example, a PDCP layer and an RLC layer of a user plane may function independently from one another, which can lead to the discarding of data packets and/or the transmission of status reports used to recover discarded data packets. Such transmissions can result in increased latency within the user plane, causing XR and other applications to provide a reduced or undesirable user experience, among other issues.

As another example, certain transmissions may include expired data units (e.g., expired RLC PDUs and/or SDUs). Such transmissions may block or prevent other packets pending in a buffer, such as packets beneficial for an application layer, from being transmitted in a timely manner.

The technology described herein provides various mechanisms that enhance the functionality of the user plane protocol stack, such as mechanisms that function to synchronize or associate certain aspects of the RLC layer and the PDCP layer to one another. For example, the technology introduces a new timer to the RLC layer that starts when the RLC layer delivers an out of sequence packet that triggers a reordering timer in the PDCP layer.

As another example, the technology may facilitate the exchange of information between peer entities (e.g., a receiving entity and its peer transmission entity), synchronizing reordering and reception/transmission windows between entities. Further, as another example, the technology enables the user plane protocol stack to prevent or avoid the transmission or retransmission of outdated (e.g., expired) packets, which may improve the capacity of the wireless communications system by increasing the efficiency of transmissions within the system.

Thus, the technology described herein enhances aspects of the RLC layer and the PDCP layer of a user plane protocol stack to prevent or mitigate issues that arise from dropped data packets, retransmissions, and so on, which cause latency and resource usage issues, among other benefits.

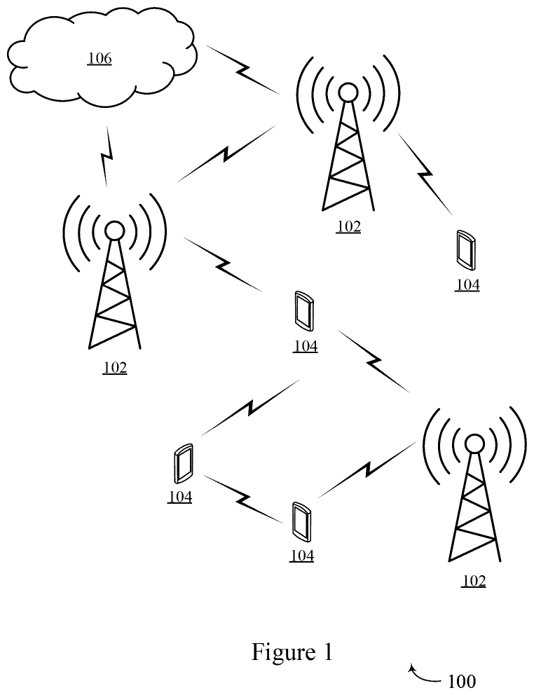

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

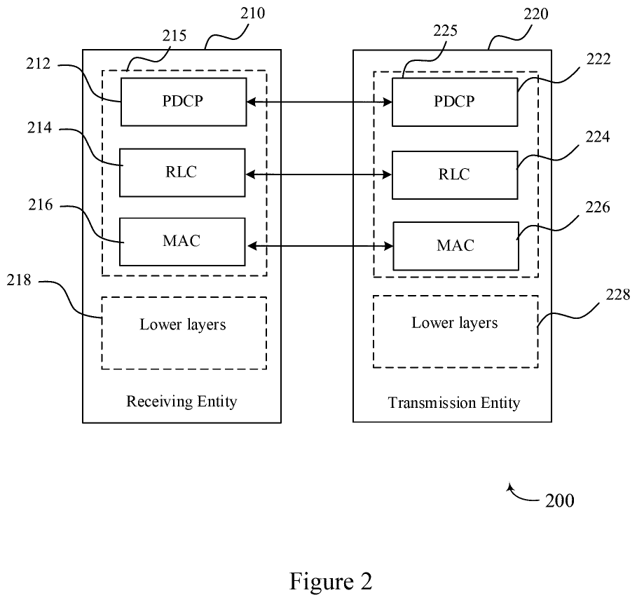

FIG. 2 illustrates an example block diagram 200 that depicts communications between a receiving entity 210 and a transmission entity 220 in accordance with aspects of the present disclosure. Each of the entities includes various protocol stacks or layers.

For example, the receiving entity 210 includes a protocol stack 215 having a PDCP layer 212, an RLC layer 214, and a MAC layer 216. The receiving entity 210 may also include lower layers 218, higher or upper layers (not shown), and so on. Similarly, the transmission entity 220 includes a protocol stack 225 having a PDCP layer 222, an RLC layer 224, and a MAC layer 226. The receiving entity 220 may also include lower layers 228, higher layers (not shown), and so on. As shown, the different layers may communicate with one another between the peer entities. For example, the RLC layer 214 may transmit status reports or other information to the RLC layer 224, as described herein.

As described herein, the PDCP layer and the RLC layer of the user plane may function independently from one another. For example, for a receiving entity, the PDCP layer maintains a reordering window to receive PDCP PDUs and transmit the SDUs to higher layers. The RLC layer of the receiving entity maintains a reception window to receive RLC PDUs and transmit the SDUs to the higher layers. In the PDCP layer, the reordering window is controlled by a t-Reordering timer that is configured by RRC. When the timer expires, the reordering window moves forward (e.g., a lower bound of the reordering window is updated from a previous SN to a new SN).

When a data packet is received outside of the reordering window, the PDCP layer of the receiving entity discards the data packet. In an RLC acknowledge mode (AM) mode, the RLC layer of the receiving entity moves its reception window when the lowest data packet in the reception window (e.g., a packet with an SN that matches the lower bound of the RLC AM reception window) has been completely received and the RLC layer has sent an acknowledgement indicating the complete reception of the data packet.

When the two layers function independently, the reception window and reordering window may not be updated at the same time. For example, when the PDCP reordering window moves forward while the RLC reception window does not change, the RLC layer may transmit data packets to the PDCP layer that are outside of the reordering window. The PDCP layer may then discard the data packets.

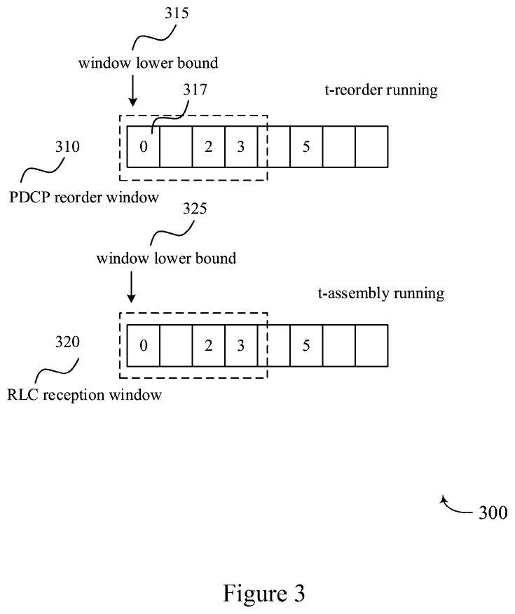

FIG. 3 illustrates an example diagram 300 that depicts PDCP and RLC reception in accordance with aspects of the present disclosure. A PDCP reordering window 310 includes a lower bound 315, represented by a COUNT of 0. For example, the lower bound 315 expects a PDU with COUNT=0 (e.g., COUNT=0 when HFN=0 and SFN=0 in case of PDCP wherein COUNT=[HFN, SN]). An RLC reception window 320 (e.g., in RLC AM) includes a lower bound 325, represented by an SN of 0.

As depicted, an RLC receiving entity has correctly and fully received data packets numbered 0, 2 and 3 (e.g., SN=0, SN=2, and SN=3) and has transmitted the data packets to the PDCP layer. The PDCP layer receives the data packets (e.g., COUNT=0, COUNT=2 (HFN=0, SFN=2), and COUNT=3 (HFN=0, SFN=3)), with a missing packet of COUNT=1 (HFN=0, SFN=1).

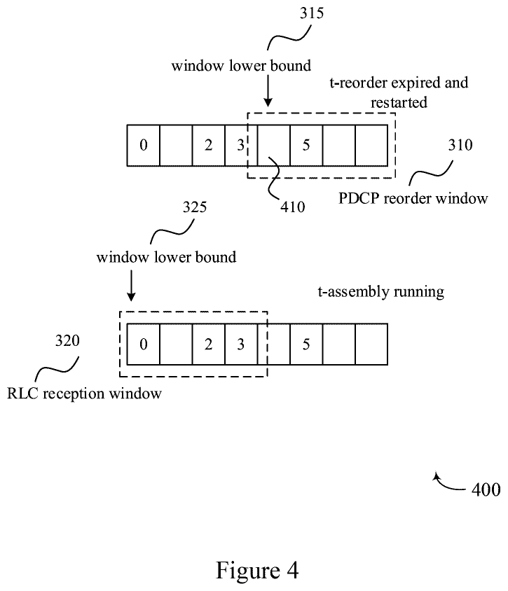

The PDCP receiving entity starts a t-Reordering timer when it receives the data packet of COUNT=2 before a data packet of COUNT=1. The RLC layer starts a t-reassembly timer because one or more segments of the data packet SN=0 are not yet received. When the t-Reordering timer expires, the PDCP reordering window 310 will update its lower bound 315 to a next data packet that has not been consecutively received. FIG. 4 illustrates an example diagram 400 that depicts PDCP and RLC reception after PDCP timer expiration in accordance with aspects of the present disclosure.

A data packet of COUNT=4 (HFN=0, SFN=4), is the next packet that has not been consecutively received after the t-Reordering timer expired, the lower bound 315 of the PDCP reordering window is moved to the data packet of COUNT=4 (e.g., a first next data packet 410. However, the t-reassembly timer of the RLC layer only triggers a status report upon its expiry and the reception window 320 does not update its lower bound 325 unless the status report contains an ACK for the data packet of SN=1. Because the RLC receiving entity has not received the data packet of SN=1, it may try to recover the packet by means of (re) transmissions.

Once the data packet is recovered by the RLC layer, it transmits or delivers the data packet to the PDCP layer, which will then discard the data packet as the data packet is outside of the reordering window 315, which has been updated with the new lower bound. Thus, the RLC layer transmits unnecessary transmissions and the PDCP layer drops data packets, causing latency and other issues within the user plane.

As described herein, in some embodiments, the RLC layer is configured with a new timer (e.g., t-Receive). The RLC layer may maintain the new timer in a similar manner to other RLC timers (e.g., on top of the t-Reassemby timer) or the PDCP timers (e.g., the t-Reordering timer.

The new timer may control the receiving or reception window (e.g., the reception window 320) of the RLC layer, similar to how the t-Reordering timer controls the reordering window (e.g., the reordering window 310) in the PDCP layer. For example, when an RLC SDU is delivered out of sequence from the RLC layer to an associated PDCP layer, the PDCP layer will start the t-Reordering timer when it receives a PDCP PDU out of order (out of an expected sequence).

The RLC layer starts the new timer, t-Receive, when the RLC layer (e.g., RLC receiving entity) delivers an out of order RLC PDU to higher layers (e.g., when the RLC layer transmits a data packet when there are one or more missing data packets in between). When the timer expires, the RLC layer may update the lower bound of its receiving window to the first SN data packet that has not yet been delivered (for which not all bytes have been received) to the higher layers after the SN packet that triggered the t-Receive timer. For example, if a data packet of SN=1 is delivered out of order, a data packet of SN=2, which has not been delivered, is associated with the updated lower bound of the receiving window.

In some cases, the expiry of the timer triggers a status report to an RLC peer entity (e.g., a transmitting entity), such as before the receiving window is updated. The transmitting entity may then update its transmission window in accordance with (e.g., to match) the receiving window that has been updated for the receiving entity. The timer stops when the missing data packet that originally triggered the timer is delivered by the RLC layer to the PDCP layer. The timer restarts when a new data packet is transmitted out of order by the RLC layer. The timer can be configured by RRC, similar to how RRC configures the t-Reordering timer for the PDCP layer. In some cases, only one timer (e.g., one t-Receive timer) runs at a time.

In some cases, such as when the t-Reassembly timer of the RLC layer is running when the t-Receive timer expires, the t-Reassembly timer stops when the data packet that triggered the t-Reassembly timer falls outside of the updated receiving window. When the data packet that triggered the t-Reassembly timer is within the updated receiving window, the t-Reassembly timer continues to run until its expiry.

Thus, the configuration and use of the new RLC timer mitigates and/or avoids unwanted latency and resource usage due to extra transmissions and/or discarded data packets, among other benefits. In some cases, the new timer benefits the delivery of data packets having small PDU delay budgets (PDBs) or PDU Set delay budgets (PDSBs), as the transmission of such data packets to higher layers is to be performed quickly to avoid issues due to latency.

In some embodiments, The RLC layer may send a status report containing “dummy” ACKs for data packets that the receiving entity no longer expects from the transmitting entity, and which were not previously correctly or completely received (e.g., data packets that are outside the updated receiving window and were not previously received and/or reassembled). The dummy ACKs may include data packets with SNs<=the SN of the data packet that triggered the t-Receive timer.

The status report may also include ACKs for data packets that were correctly received in sequence by the RLC receiving entity, including the data packets received in sequence with an SN>SN for the data packet that triggered the t-Receive timer). For example, if data packets having SNs of 1, 2, and 3 were received in order and a data packet of SN=5 was received before a data packet of SN=4, the RLC receiving entity starts the new timer, t-Receive. Upon expiry of the timer, the RLC receiving entity sends a status report including an ACK for the data packets having SNs of 1, 2, 3, and 5 and an ACK (e.g, the dummy ACK) for the data packet of SN=4, even though the data packet of SN=4 was not fully or correctly received by the RLC receiving entity. The RLC layer then updates the lower bound of the RLC receiving window to a data packet of SN=6, which was not previously delivered to the higher layers. The transmission window (at the peer entity) is accordingly updated once the status report is received.

In some embodiments, the receiving entity may utilize a new status PDU format to indicate that the status is or was triggered due to a window update (e.g., an update to the receiving window) instead of a normal ACK/NACK procedure performed by the RLC layer. For example, a CPT field in a control PDU may include a certain value of “001” to indicate a “Window Update” and a status PDU may only include ACK_SN, El, and R fields, where the El field has a value of “0.”

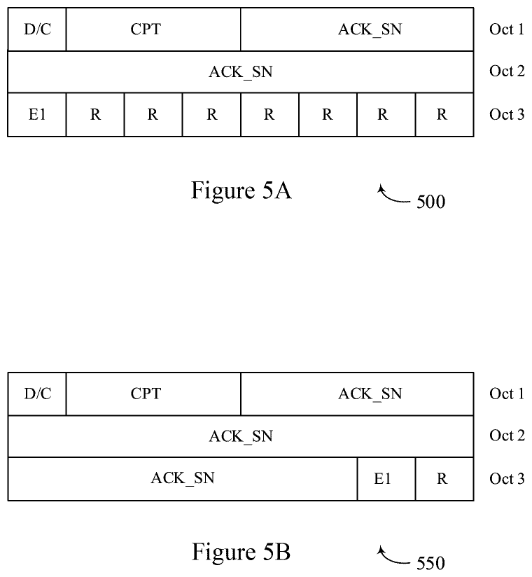

FIGS. 5A-5B illustrate example control PDU structures in accordance with aspects of the present disclosure. For example, a control PDU structure 500 of FIG. 5A depicts a window update status PDU with a 12-bit SN, and a control PDU structure 550 of FIG. 5B depicts a window update status PDU with an 18-bit SN.

In some embodiments, the value of the new timer may be set to the same value as the value of the t-Reordering timer, which facilitates synchronization between the receiving window in the RLC layer and the reordering window in the PDCP layer. For example, the t-Receive timer may have values from Oms to 3000 ms. In some cases, the value of the new timer may be set to an offset from the value of the t-Reordering timer to account for any additional time between the delivery of a data packet from the layer RLC to the layer PDCP and the start of the t-Reordering timer. For example, when the time difference between the start of the t-Reordering timer and the transmission of an out of order data packet by the RLC receiving entity is x ms, the value of the t-Receive timer may be set to value of t-Reordering timer+x ms.

In some embodiments, a PDCP receiving entity (e.g., the PDCP layer) informs the RLC receiving entity (e.g., the RLC layer) when a reordering window has advanced or been updated with a new lower bound. The receiving entity then informs its peer entity (e.g., the transmission entity) to advance its transmission window accordingly. Thus, the reordering window in the PDCP layer and the reception or receiving window in the RLC layer may update their lower bounds synchronously, avoid unnecessary latencies caused by transmissions due to missing data packets and preserving the resources used for the transmissions, among other benefits.

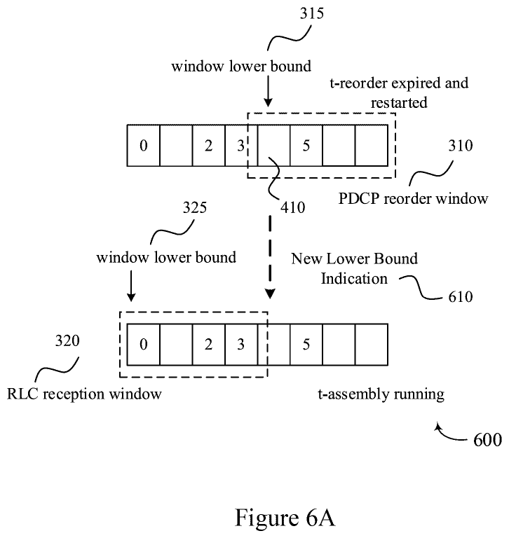

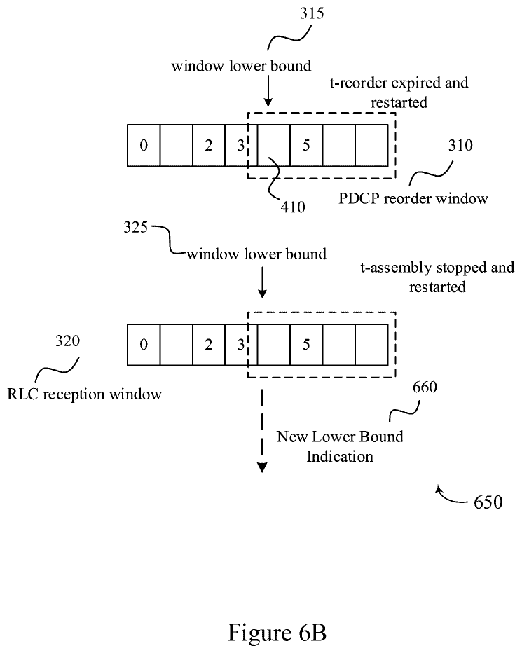

FIG. 6A illustrates an example diagram 600 that depicts a PDCP indication to an RLC in accordance with aspects of the present disclosure. The PDCP receiving entity transmits an indication (e.g., a new lower bound indication 610) to the RLC receiving entity whenever the t-Reordering timer expires and the reordering window 310 is updated. Using the indication 610, the RLC layer updates its reception window 320 accordingly.

The indication 610 may contain or include information of a new lower bound of the PDCP reordering window 310, enabling the RLC layer to determine whether data packets may fall outside of the updated PDCP reordering window. When the RLC receiving entity receives the indication 610, it checks whether the lower bound of its receiving window matches the new lower bound of the updated PDCP reordering window. If not, the RLC layer advances its receiving window to match the PDCP reordering window. The RLC layer may then inform a peer entity of the change in its receiving window 320.

FIG. 6B illustrates an example diagram 650 that depicts an RLC receiving entity sending an indication to a transmission entity in accordance with aspects of the present disclosure. The RLC receiving entity transmits an indication (e.g., a new lower bound indication 660) to a peer entity, such as via an RLC status report. The RLC status report may indicate a dummy ACK, as described herein, for data packets that the receiving entity no longer expects to receive within the updated window.

In some cases, the status report may be or include a new control PDU associated with a window update, as described herein. The peer entity, upon receiving the status report, can then update its RLC transmission window, matching the updated receiving window and the reordering window of the PDCP layer.

In some embodiments, the information within the indication from the PDCP receiving entity to the RLC receiving entity may include the SN of the RX_DELIV packet in PDCP, where the SN is extracted from the COUNT value of the RX_DELIV packet. The RLC receive entity may then use the SN of the RX_DELIV packet in PDCP (received from the indication) to correlate the SN to the SN of a corresponding RLC packet. The RLC may maintain an offset value to correlate the PDCP SN to the corresponding RLC SN. For example, if the PDCP RX_DELIV SN value is y numbers ahead of the RLC SN, the RLC may calculate its corresponding SN as RX_DELIV SN-y.

In some embodiments, a transmitting side of the PDCP layer maintains a discardTimer for each SDU that it receives from higher layers. The value of the discardTimer may be configured by RRC and may be set according to the PDB/PSDB of the SDU. The t-Reordering timer on the receiving side may be set to a value equal to that of the discardTimer. When the discardTimer of an SDU expires, the PDCP transmitting entity discards the data packet. When the data packet was previously transmitted to lower layers, the PDCP transmitting entity indicates the discarding of the data packet to the lower layers.

The RLC transmitting entity may update its transmission window using such information. For example, when the RLC transmitting entity receives an indication of discarded packets from the PDCP layer, the RLC transmitting entity may check if the SDU was previously transmitted or not transmitted. When the data packets were not delivered to lower layers, the RLC transmitting entity may discard the data packets and reassign their SNs to new SDUs. In such cases, the RLC transmitting entity may not update its transmission window or reception window.

However, when the SDU was transmitted to lower layers by the RLC layer, the RLC transmitting entity sends an indication to the RLC receiving entity to update its receiving window. Once the indication is sent, the transmitting entity can discard the SDU from its (re) transmission buffers. The indication may be sent in the form of a new control PDU, triggered due to a “Window Update” as described herein.

To avoid additional delays in updating the PDCP reordering window, the RLC receiving entity may also send an indication to the PDCP receiving entity. The indication may contain information about the new lower bound for its receiving window, and the PDCP layer may update its reordering window immediately and without waiting for the t-Reordering timer to expire.

In some cases, the RLC receiving entity may send the SN value of the lower bound packet of the new receiving window in the indication transmitted to the PDCP receiving entity. The PDCP receiving entity may then use the SN value to correlate the SN to a corresponding COUNT value for an RX_DELIV of the updated reordering window. The PDCP layer may maintain a new offset value to calculate the corresponding COUNT value when it receives the indication from the RLC layer. For example, if the PDCP RX_DELIV SN is z numbers ahead of the RLC layer SN, the PDCP receiving entity can calculate the new RX_DELIV SN as z+RLC SN.

Further, in some embodiments, the reordering window of the PDCP layer may be decoupled from the t-Reordering timer of the PDCP layer. By decoupling the reordering window from the t-Reordering timer, any advancement of the reordering window may be based on when it completely receives a PDCP PDU from the RLC layer.

In some embodiments, the t-Reordering timer value is set to infinity, such that it never expires. The reordering window may transmit all PDUs that it receives to higher layers immediately, provided header decompression is performed (if not already decompressed) after it receives the data packet if outOfOrderDelivery is configured. If outOfOrderDelivery is not configured, the reordering window may only update as and when it receives a PDU with a COUNT value consecutive to that of the RX_DELIV (e.g., the state variable indicates the COUNT value of the first PDCP SDU not delivered to the upper layers—it is the COUNT value of the lower bound of the reordering window) COUNT value.

In some embodiments, the t-Reordering timer maintained by the PDCP receiving entity is removed. For example, RRC no longer configures the timer for the PDCP receiving entity and the reordering window is based on the reception of PDCP PDUs and whether outOfOrderDelivery is configured.

In some embodiments, the t-Reordering timer may be configured by RRC with a non-infinity value, but not affect the lower bound of the reordering window. The timer may only be configured if outOfOrderDelivery has not been configured. The timer only dictates the time allowed by the receiving entity to deliver the received PDUs in order. The timer starts when a PDU is received by the PDCP receiving entity out of order. Once the timer expires, the receiving entity delivers all PDUs received until the expiry of the timer, regardless of whether the PDUs are in order or not in order. The reordering window may then wait until it recovers the missing packets before it can advance its lower bound and restart the t-Reordering timer.

Thus, by enabling PDCP layers and RLC layers to function intelligently, window updates can be performed in a synchronous manner regardless of whether an RLC layer has recovered missing data packets. As described herein, the RLC layer may include a new timer and/or there may be interlayer communications that indicate the window updates.

As described herein, in some embodiments, the user plane may be enhanced to avoid, mitigate, and/or prevent the transmission/retransmission of outdated packets or other packets that satisfy a certain or predetermined condition, such as outdated RLC PDUs/SDUs. An outdated packet or data unit may be, for example, a packet or data unit (e.g., RLC PDU or RLC SDU) where a PDCP discard timer of a corresponding PDCP SDU is or has expired.

In some embodiments, an RLC transmission entity (or, transmitting entity) informs a peer RLC receiving entity, using a new or certain control signaling, about outdated RLC PDUs/SDUs (e.g., the PDCP discardTimer or PDCP discardTimerLowImportance of a corresponding PDCP SDU has expired). For example, the RLC transmission entity transmits to the RLC receiving entity a new RLC control PDU, which indicates outdated RLC PDUs (e.g., RLC PDUs that are unusable to the application layer). The RLC control PDU may include or contain the SNs of the outdated RLC PDUs.

In some cases, the RLC transmission entity may trigger RLC control information that comprises one or more sequence numbers (SNs) associated with one or more RLC PDUs that satisfy a condition, such as a predetermined condition that defines whether an RLC PDU is outdated or not outdated. For example, the RLC transmission entity may receive information from an upper layer (e.g., a PDCP layer) that comprises a discard indication for the RLC PDU.

As described herein, an outdated packet or data unit, such as an outdated RLC PDU, may include a packet/data unit having an associated delay budget that has been exceeded, and thus is no longer of use to an application layer. For example, an outdated RLC PDU includes any RLC PDU where a corresponding PDCP SDU/PDU is or has been already discarded (e.g., the PDCP PDCP discardTimer is expired).

In some embodiments, the RLC control PDU may be of variable size and include a set of SNs for which the corresponding RLC SDUs/PDUs are determined to be outdated. In some cases, the RLC control PDU may include a field denoting an SN of a first outdated RLC PDU/SDU (e.g., a smallest SN of a group of outdated RLC PDUs) and a bitmap indicating some or all further subsequent outdated RLC PDUs (in cases where multiple RLC PDUs are outdated).

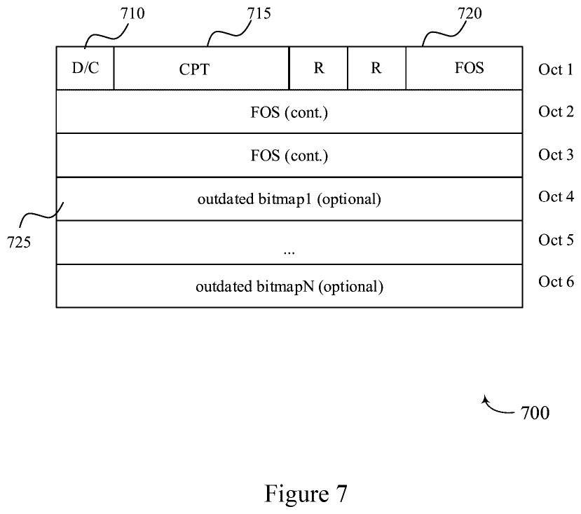

FIG. 7 illustrates an example control PDU 700 in accordance with aspects of the present disclosure. As described herein, the control PDU 700, or RLC control PDU, may include a report on outdated SNs. The control PDU 700 includes a D/C field 710, which indicates a type of PDU (e.g., an RLC control PDU or RLC data PDU/SDU), a CPT field 715, which indicates the type of RLC control PDU (e.g., the PDU is an RLC outdated SN report).

Further, a first outdated SN (FOS) field 720 indicates a smallest SN value (among all SNs associated with outdated RLC PDUs), and an outdated bitmap field 725, or fields, indicates the RLC PDUs/SDUs that are outdated and/or the PDUs/SDUs that are not outdated. For example, the bit position of the N^{th} bit in the outdated bitmap is N (e.g., the bit position of the first bit in the outdated bitmap is 1. An outdated bitmap may be represented by Table 1, as follows:

TABLE 1

| Bit | Description |
|---|---|
| 0 | RLC PDU with corresponding SN for which the |
| | delay budget is not exceeded |
| 1 | RLC PDU with corresponding SN is outdated SN |

In some embodiments, the RLC transmission entity triggers a new RLC control PDU (e.g., an RLC outdated SN report) when the PDCP layer informs or instructs the RLC transmission entity to discard a specified or distinguished RLC SDU and the RLC transmission entity cannot discard the indicated RLC SDU. For example, the RLC transmission entity may have submitted the RLC SDU, or a segment of the RLC SDU, to lower layers (e.g., the MAC layer) for transmission and thus is not allowed to discard the RLC SDU (or PDU). The discard indication may be caused by an expiry of the PDCP DiscardTimer or due to other factors (e.g., dependency information (inter-dependent PDUs/PDU sets) and/or redundant PDUs with respect to AL-FEC, or application layer forward error correction). However, in some cases, the new RLC control PDU (e.g., control PDU 700) is to be triggered whenever a RLC PDU is pending for transmission/retransmission and at least a segment of the PDU has been already submitted to the MAC layer for transmission, even though a corresponding PDCP SDU has been discarded.

In some embodiments, the network (e.g., the NE 102) configures (e.g., via RRC configuration), the RLC transmission entity to trigger/send an RLC outdated SN report (e.g., using a new RLC control PDU, such as control PDU 700). For example, an RLC configuration IE (e.g., RLCconfig IE) may include a new field that indicates whether the RLC transmission entity is authorized or enabled to inform a peer RLC receiving entity about outdated RLC PDUs. In some cases, the reporting of such information may benefit certain types of data or traffic (e.g., XR data or traffic), and the network may configure such reporting capabilities per LCH/RLC entity.

In some embodiments, an RLC receiving entity triggers, in response to the reception of the RLC control PDU 700, an RLC status report. For example, the RLC status report may include or contain “dummy” ACKs for the RLC PDUs/SDUs/packets that were indicated as outdated within the RLC control PDU 700. The status for the outdated RLC PDUs/SDUs may be set to ACK in the RLC status report regardless of any actual reception status, such as when the RLC PDUs are indicated as ACK even though they are yet not received by the RLC receiving entity.

Setting the status for the outdated RLC PDUs to ACK enforces or otherwise causes the outdated packets at the RLC transmission entity to be discarded, avoiding unnecessary transmission of the outdated RLC PDUs. In response, the RLC transmission entity may update an associated transmission window and corresponding state variables. For example, the RLC receiving entity may determine RLC PDUs that are indicated as outdated (e.g., based on receiving the RLC control PDU 700) as being successfully received and update associated state variables/receiving window accordingly (e.g., update RX_Next, RX_Next_Status_Trigger, RX_Highest_Status, RX_Next_Highest, and so on).

As an example, upon receiving an RLC outdated SN report from lower layers, the RLC receiving entity may determine that any RLC PDU, having a bit in the outdated bitmap set to “1” or having an associated SN value equal to the value of the FOS field as being successfully received. In another example the receiving RLC entity may determine a RLC PDU/SDU as discarded when a bit is set to “1” in the outdated bitmap field 725 and/or when an associated SN value equal is to the value of the FOS field 720. The RLC receiving entity may trigger the transmission of an RLC STATUS report in response to receiving the RLC control PDU 700 indicating the SNs of the outdated RLC PDUs and indicate the outdated RLC PDUs as being successfully received (e.g., ACK).

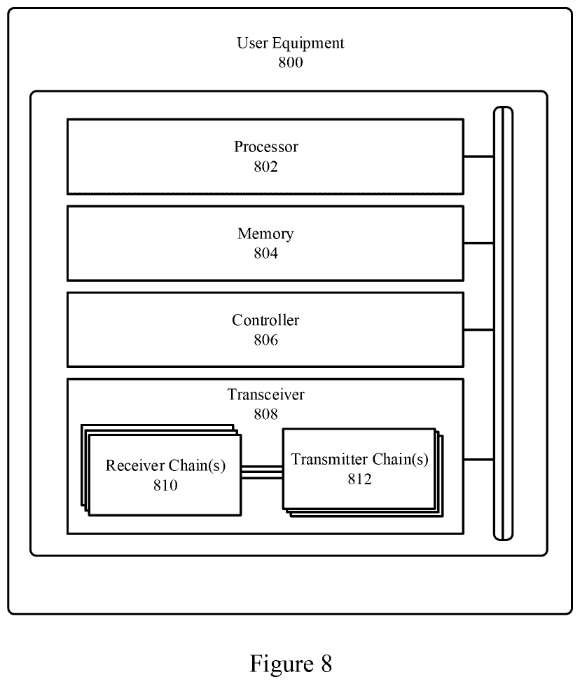

FIG. 8 illustrates an example of a UE 800 in accordance with aspects of the present disclosure. The UE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the UE 800 to perform various functions of the present disclosure.

The memory 804 may include volatile or non-volatile memory. The memory 804 may store computer-readable, computer-executable code including instructions when executed by the processor 802 cause the UE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the UE 800 to perform one or more of the functions described herein (e.g., executing, by the processor 802, instructions stored in the memory 804). For example, the processor 802 may support wireless communication at the UE 800 in accordance with examples as disclosed herein. The UE 800 may be configured to support a means for receiving, by an RLC transmission entity, information from an upper layer, determining, by the RLC transmission entity and based at least in part on the received information, one or more RLC PDUs that satisfy a condition, triggering, by the RLC transmission entity, transmission of RLC control information that comprises one or more SNs associated with the one or more RLC PDUs that satisfy the condition, generating an RLC control PDUI that includes the RLC control information, and transmitting the generated RLC control PDU from the RLC transmission entity to a peer receiving RLC entity.

The controller 806 may manage input and output signals for the UE 800. The controller 806 may also manage peripherals not integrated into the UE 800. In some implementations, the controller 806 may utilize an operating system such as iOS®, ANDROID®, WINDOWS®, or other operating systems. In some implementations, the controller 806 may be implemented as part of the processor 802.

In some implementations, the UE 800 may include at least one transceiver 808. In some other implementations, the UE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receive the signal over the air or wireless medium. The receiver chain 810 may include at least one amplifier (e.g., a low-noise amplifier (LNA)) configured to amplify the received signal. The receiver chain 810 may include at least one demodulator configured to demodulate the receive signal and obtain the transmitted data by reversing the modulation technique applied during transmission of the signal. The receiver chain 810 may include at least one decoder for decoding the processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

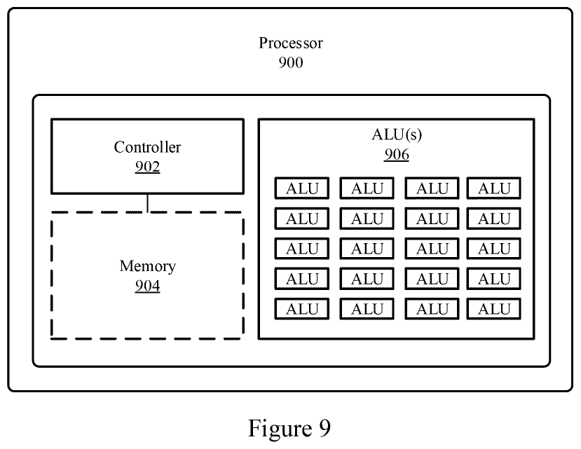

FIG. 9 illustrates an example of a processor 900 in accordance with aspects of the present disclosure. The processor 900 may be an example of a processor configured to perform various operations in accordance with examples as described herein. The processor 900 may include a controller 902 configured to perform various operations in accordance with examples as described herein. The processor 900 may optionally include at least one memory 904, which may be, for example, an L1/L2/L3 cache. Additionally, or alternatively, the processor 900 may optionally include one or more arithmetic-logic units (ALUs) 906. One or more of these components may be in electronic communication or otherwise coupled (e.g., operatively, communicatively, functionally, electronically, electrically) via one or more interfaces (e.g., buses).

The processor 900 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 900) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 902 may be configured to manage and coordinate various operations (e.g., signaling, receiving, obtaining, retrieving, transmitting, outputting, forwarding, storing, determining, identifying, accessing, writing, reading) of the processor 900 to cause the processor 900 to support various operations in accordance with examples as described herein. For example, the controller 902 may operate as a control unit of the processor 900, generating control signals that manage the operation of various components of the processor 900. These control signals include enabling or disabling functional units, selecting data paths, initiating memory access, and coordinating timing of operations.

The controller 902 may be configured to fetch (e.g., obtain, retrieve, receive) instructions from the memory 904 and determine subsequent instruction(s) to be executed to cause the processor 900 to support various operations in accordance with examples as described herein. The controller 902 may be configured to track memory address of instructions associated with the memory 904. The controller 902 may be configured to decode instructions to determine the operation to be performed and the operands involved. For example, the controller 902 may be configured to interpret the instruction and determine control signals to be output to other components of the processor 900 to cause the processor 900 to support various operations in accordance with examples as described herein. Additionally, or alternatively, the controller 902 may be configured to manage flow of data within the processor 900. The controller 902 may be configured to control transfer of data between registers, arithmetic logic units (ALUs), and other functional units of the processor 900.

The memory 904 may include one or more caches (e.g., memory local to or included in the processor 900 or other memory, such RAM, ROM, DRAM, SDRAM, SRAM, MRAM, flash memory, etc. In some implementations, the memory 904 may reside within or on a processor chipset (e.g., local to the processor 900). In some other implementations, the memory 904 may reside external to the processor chipset (e.g., remote to the processor 900).

The memory 904 may store computer-readable, computer-executable code including instructions that, when executed by the processor 900, cause the processor 900 to perform various functions described herein. The code may be stored in a non-transitory computer-readable medium such as system memory or another type of memory. The controller 902 and/or the processor 900 may be configured to execute computer-readable instructions stored in the memory 904 to cause the processor 900 to perform various functions. For example, the processor 900 and/or the controller 902 may be coupled with or to the memory 904, the processor 900, the controller 902, and the memory 904 may be configured to perform various functions described herein. In some examples, the processor 900 may include multiple processors and the memory 904 may include multiple memories. One or more of the multiple processors may be coupled with one or more of the multiple memories, which may, individually or collectively, be configured to perform various functions herein.

The one or more ALUs 906 may be configured to support various operations in accordance with examples as described herein. In some implementations, the one or more ALUs 906 may reside within or on a processor chipset (e.g., the processor 900). In some other implementations, the one or more ALUs 906 may reside external to the processor chipset (e.g., the processor 900). One or more ALUs 906 may perform one or more computations such as addition, subtraction, multiplication, and division on data. For example, one or more ALUs 906 may receive input operands and an operation code, which determines an operation to be executed. One or more ALUs 906 be configured with a variety of logical and arithmetic circuits, including adders, subtractors, shifters, and logic gates, to process and manipulate the data according to the operation. Additionally, or alternatively, the one or more ALUs 906 may support logical operations such as AND, OR, exclusive-OR (XOR), not-OR (NOR), and not-AND (NAND), enabling the one or more ALUs 906 to handle conditional operations, comparisons, and bitwise operations.

The processor 900 may support wireless communication in accordance with examples as disclosed herein. For example, the processor 900 may be configured to or operable to support a means for receiving, by an RLC transmission entity, information from an upper layer, determining, by the RLC transmission entity and based at least in part on the received information, one or more RLC PDUs that satisfy a condition, triggering, by the RLC transmission entity, transmission of RLC control information that comprises one or more SNs associated with the one or more RLC PDUs that satisfy the condition, generating an RLC control PDUI that includes the RLC control information, and transmitting the generated RLC control PDU from the RLC transmission entity to a peer receiving RLC entity.

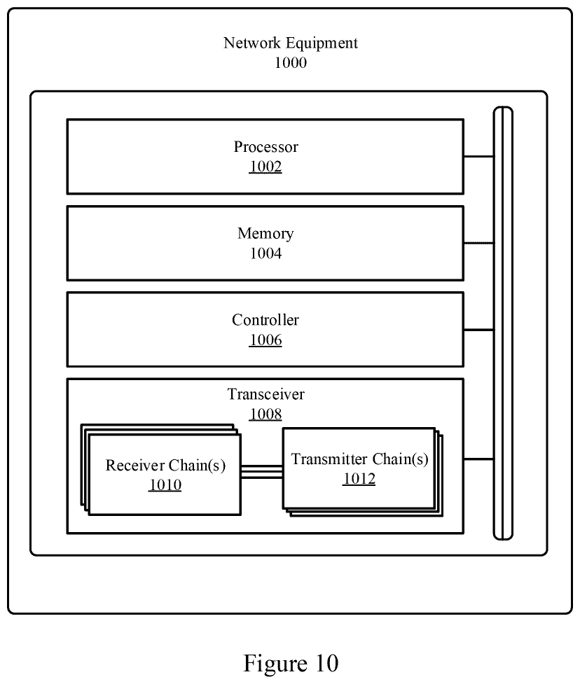

FIG. 10 illustrates an example of a NE 1000 in accordance with aspects of the present disclosure. The NE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the NE 1000 to perform various functions of the present disclosure.

The memory 1004 may include volatile or non-volatile memory. The memory 1004 may store computer-readable, computer-executable code including instructions when executed by the processor 1002 cause the NE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the NE 1000 to perform one or more of the functions described herein (e.g., executing, by the processor 1002, instructions stored in the memory 1004).

For example, the processor 1002 may support wireless communication at the NE 1000 in accordance with examples as disclosed herein. The NE 1000 may be configured to support a means for receiving, at an RLC receiving entity, an RLC control PDU from a peer RLC transmission entity, wherein the RLC control PDU includes RLC control information that comprises one or more sequence numbers (SNs) associated with one or more RLC PDUs that satisfy a condition, and triggering, by the RLC receiving entity, a STATUS report based on the RLC control information from the RLC control PDU.

The controller 1006 may manage input and output signals for the NE 1000. The controller 1006 may also manage peripherals not integrated into the NE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the NE 1000 may include at least one transceiver 1008. In some other implementations, the NE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

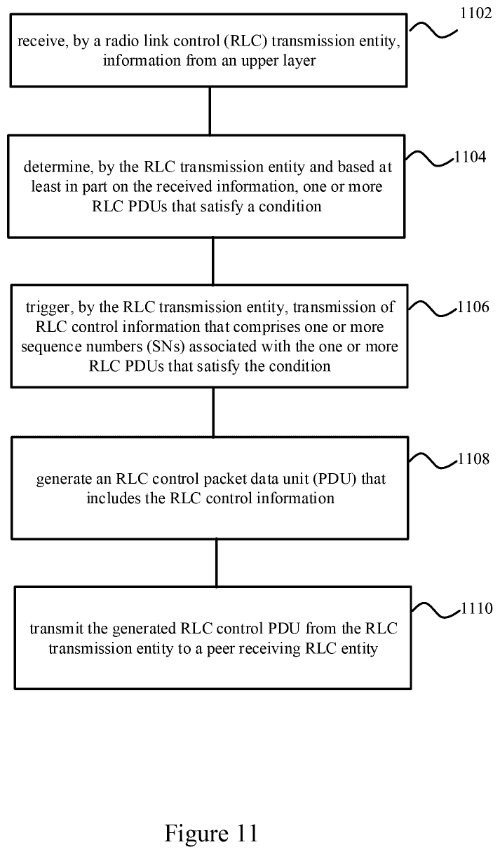

FIG. 11 illustrates a flowchart of a method in accordance with aspects of the present disclosure. The operations of the method may be implemented by a UE as described herein. In some implementations, the UE may execute a set of instructions to control the function elements of the UE to perform the described functions.

At 1102, the method may include receiving, by an RLC transmission entity, information from an upper layer. The operations of 1102 may be performed in accordance with examples as described herein. In some implementations, aspects of the operations of 1102 may be performed by a UE as described with reference to FIG. 8.

At 1104, the method may include determining, by the RLC transmission entity and based at least in part on the received information, one or more RLC PDUs that satisfy a condition. The operations of 1104 may be performed in accordance with examples as described herein. In some implementations, aspects of the operations of 1104 may be performed by a UE as described with reference to FIG. 8.

At 1106, the method may include triggering, by the RLC transmission entity, transmission of RLC control information that comprises one or more SNs associated with the one or more RLC PDUs that satisfy the condition. The operations of 1106 may be performed in accordance with examples as described herein. In some implementations, aspects of the operations of 1106 may be performed by a UE as described with reference to FIG. 8.

At 1108, the method may include generating an RLC control PDU that includes the RLC control information. The operations of 1108 may be performed in accordance with examples as described herein. In some implementations, aspects of the operations of 1108 may be performed by a UE as described with reference to FIG. 8.

At 1110, the method may include transmitting the generated RLC control PDU from the RLC transmission entity to a peer receiving RLC entity. The operations of 1110 may be performed in accordance with examples as described herein. In some implementations, aspects of the operations of 1110 may be performed by a UE as described with reference to FIG. 8.

It should be noted that the method described herein describes a possible implementation, and that the operations and the steps may be rearranged or otherwise modified and that other implementations are possible.

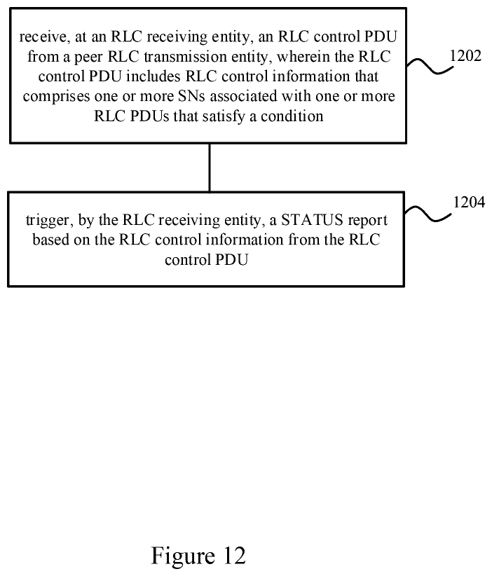

FIG. 12 illustrates a flowchart of a method in accordance with aspects of the present disclosure. The operations of the method may be implemented by an NE as described herein. In some implementations, the NE may execute a set of instructions to control the function elements of the NE to perform the described functions.

At 1202, the method may include receiving, at an RLC receiving entity, an RLC control PDU from a peer RLC transmission entity, wherein the RLC control PDU includes RLC control information that comprises one or more SNs associated with one or more RLC PDUs that satisfy a condition. The operations of 1202 may be performed in accordance with examples as described herein. In some implementations, aspects of the operations of 1202 may be performed by an NE as described with reference to FIG. 10.

At 1204, the method may include triggering, by the RLC receiving entity, a STATUS report based on the RLC control information from the RLC control PDU. The operations of 1204 may be performed in accordance with examples as described herein. In some implementations, aspects of the operations of 1204 may be performed an NE as described with reference to FIG. 10.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive, by a radio link control (RLC) transmission entity, information from an upper layer;
determine, by the RLC transmission entity and based at least in part on the received information, one or more RLC packet data units (PDUs) that satisfy a condition;
trigger, by the RLC transmission entity, transmission of RLC control information that comprises one or more sequence numbers (SNs) associated with the one or more RLC PDUs that satisfy the condition;
generate an RLC control PDU that includes the RLC control information; and
transmit the generated RLC control PDU from the RLC transmission entity to a peer receiving RLC entity.

2. The UE of claim 1, wherein the information received from the upper layer comprises a discard indication for the one or more RLC PDUs received from a packet data convergence protocol (PDCP) layer.

3. The UE of claim 2, wherein the at least one processor is further configured to cause the UE to:
maintain the one or more RLC PDUs determined to satisfy the condition in a corresponding buffer in response to receiving the discard indication from the PDCP layer.

4. The UE of claim 1, wherein the one or more RLC PDUs that satisfy the condition comprise RLC PDUs for which an associated delay budget is exceeded.

5. The UE of claim 1, wherein the at least one processor is configured to cause the UE to determine an RLC PDU satisfies the condition when a packet data convergence protocol (PDCP) discard timer of a corresponding PDCP service data unit (SDU) is expired.

6. The UE of claim 1, wherein the RLC PDU includes:
a field that indicates a smallest SN value for the one or more SNs; and
a bitmap field that indicates the one or more RLC PDUs that satisfy the condition.

7. The UE of claim 6, wherein the bitmap field indicates outdated RLC PDUs and RLC PDUs that are not outdated.

8. A processor for wireless communication, comprising:
at least one controller coupled with at least one memory and configured to cause the processor to:
receive, by a radio link control (RLC) transmission entity, information from an upper layer;
determine, by the RLC transmission entity and based at least in part on the received information, one or more RLC packet data units (PDUs) that satisfy a condition;
trigger, by the RLC transmission entity, transmission of RLC control information that comprises one or more sequence numbers (SNs) associated with the one or more RLC PDUs that satisfy the condition;
generate an RLC control PDU that includes the RLC control information; and
transmit the generated RLC control PDU from the RLC transmission entity to a peer receiving RLC entity.

9. The processor of claim 8, wherein the information received from the upper layer comprises a discard indication for the one or more RLC PDUs received from a packet data convergence protocol (PDCP) layer.

10. The processor of claim 9, wherein the at least one controller is further configured to cause the processor to:
maintain the one or more RLC PDUs determined to satisfy the condition in an RLC buffer in response to receiving the discard indication from the PDCP layer.

11. The processor of claim 8, wherein the one or more RLC PDUs that satisfy the condition comprise RLC PDUs for which an associated delay budget is exceeded.

12. The processor of claim 8, wherein the at least one controller is configured to cause the processor to determine an RLC PDU satisfies the condition when a packet data convergence protocol (PDCP) discard timer of a corresponding PDCP service data unit (SDU) is expired.

13. The processor of claim 8, wherein the RLC PDU includes:
a field that indicates a smallest SN value for the one or more SNs; and
a bitmap field that indicates the one or more RLC PDUs that satisfy the condition.

14. The processor of claim 13, wherein the bitmap field indicates outdated RLC PDUs and RLC PDUS that are not outdated.

15. A method performed by a user equipment (UE), the method comprising:
receiving, by a radio link control (RLC) transmission entity, information from an upper layer;
determining, by the RLC transmission entity and based at least in part on the received information, one or more RLC packet data units (PDUs) that satisfy a condition;
triggering, by the RLC transmission entity, transmission of RLC control information that comprises one or more sequence numbers (SNs) associated with the one or more RLC PDUs that satisfy the condition;
generating an RLC control PDU that includes the RLC control information; and
transmitting the generated RLC control PDU from the RLC transmission entity to a peer receiving RLC entity.

16. The method of claim 15, wherein the information received from the upper layer comprises a discard indication for the one or more RLC PDUs received from a packet data convergence protocol (PDCP) layer.

17. The method of claim 16, further comprising:
maintaining the one or more RLC PDUs determined to satisfy the condition in an RLC buffer in response to receiving the discard indication from the PDCP layer.

18. A network entity for wireless communication, comprising:
at least one memory; and
at least one processor coupled with the at least one memory and configured to cause the network entity to:
receive, at a radio link control (RLC) receiving entity, a radio link control (RLC) control packet data unit (PDU) from a peer RLC transmission entity,
wherein the RLC control PDU includes RLC control information that comprises one or more sequence numbers (SNs) associated with one or more RLC PDUs that satisfy a condition; and
trigger, by the RLC receiving entity, a STATUS report based on the RLC control information from the RLC control PDU.

19. The network entity of claim 18, wherein the STATUS report comprises information that indicates a positive and negative acknowledgement for one or more RLC PDUs.

20. The network entity of claim 19, wherein the STATUS report comprises information that indicates a positive acknowledgement for the one or more RLC PDUs indicated by the by the RLC control PDU.
